(19) United States
(12) Patent Application Publication
(10) Pub. No.: US 2005/0216369 A1
(43) Pub. Date: Sep. 29, 2005

(54) Process for sorting recyclable material

(76) Inventor: Chris Honegger, Bluffton, IN (US)

Correspondence Address: CARLSON, GASKEY & OLDS, P.C., 400 WEST MAPLE ROAD, SUITE 350, BIRMINGHAM, MI, 48009, US

(21) Appl. No.: 10/788,165

(22) Filed: Feb. 26, 2004

(51) Int. Cl. G06F 17/60; G06F 7/00

(52) U.S. Cl. 705/28; 700/214

(57) ABSTRACT

A system for sorting and processing recyclable materials includes a sorting station including a loading conveyor and a data collection area. Containers received from various distribution centers are loaded onto the load conveyor and moved to the data collection area. The contents of the container are recorded with corresponding weight and origin information. The information recorded regarding the contents of the container is used to credit distribution centers for reimbursement. The recyclable material is unloaded from the container and directed to the proper processing station and prepared for shipment to an end user of the recyclable material.

### BACKGROUND OF THE INVENTION

This invention relates to a recycling process, and more specifically to a recycling process for sorting, counting and preparing recyclable materials for reuse.

Many states have instituted recycling laws that charge a deposit fee with each purchase of a beverage container. The deposit fee is returned to the purchaser upon return of the container. The deposit fee encourages consumers to return empty containers instead of throwing them away. Typically, purchasers return the containers to distribution centers such as shopping centers. Those shopping centers sort the containers and send the sorted material to processing centers.

The processing centers receive, count and prepare the containers for reuse. Preparation for reuse includes the sorting of containers by material type. For example, green glass, brown glass, clear glass, cans, and plastic bottles. The glass is sorted by color and crushed. The cans and plastic bottles are sorted and baled into easily handled bundles for further processing.

Typically, only a few process centers service many distribution and shopping centers. Each process center receives large quantities of recyclable containers for sorting and processing. Sorting and counting the large quantities of recyclable material received from distribution centers can be costly and time-consuming. In addition, an accurate accounting of recyclable material is required to credit the distribution centers and collect from the container manufactures.

Accordingly, it is desirable to develop a method and process for efficiently, and economically sorting and preparing recyclable material for reuse.

### SUMMARY OF THE INVENTION

The present invention is a method and system for sorting, counting and preparing recyclable material for reuse.

The system of this invention includes a cell with a loading conveyor and a sorting and data collection station. Containers filled with recyclable material received from various distribution centers are loaded onto the load conveyor and moved to the sorting and data collection station. The container includes a label with container origin information, which is read and recorded in a database. The category and weight of the recyclable material within each container is also recorded in the database along with corresponding weight and origin information. The category of recyclable material includes glass, cans or plastic bottles. The recyclable material is unloaded from the container and moved to the proper processing station. At the processing stations, each category of recyclable material is prepared for shipment to an end user.

Accordingly, the system and process of this invention increases the efficiency of sorting, counting and processing recyclable materials received from various distribution centers and prepares that material for reuse.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic illustration of a recyclable material sorting and processing system according to this invention;

FIG. 2 is a schematic illustration of another recyclable material sorting and processing system according to this invention;

FIG. 3 is a schematic illustration of a sorting station;

FIG. 4 is a schematic illustration of a container;

FIG. 5 is a schematic illustration of a control box;

FIG. 6 is a schematic illustration of a can and plastic bottle conveyor and processing stations according to this invention; and

FIG. 7 is a schematic illustration of a glass conveyor and processing station according to this invention.

### DETAILED DESCRIPTION OF THE PREFERRED EMBODIMENT

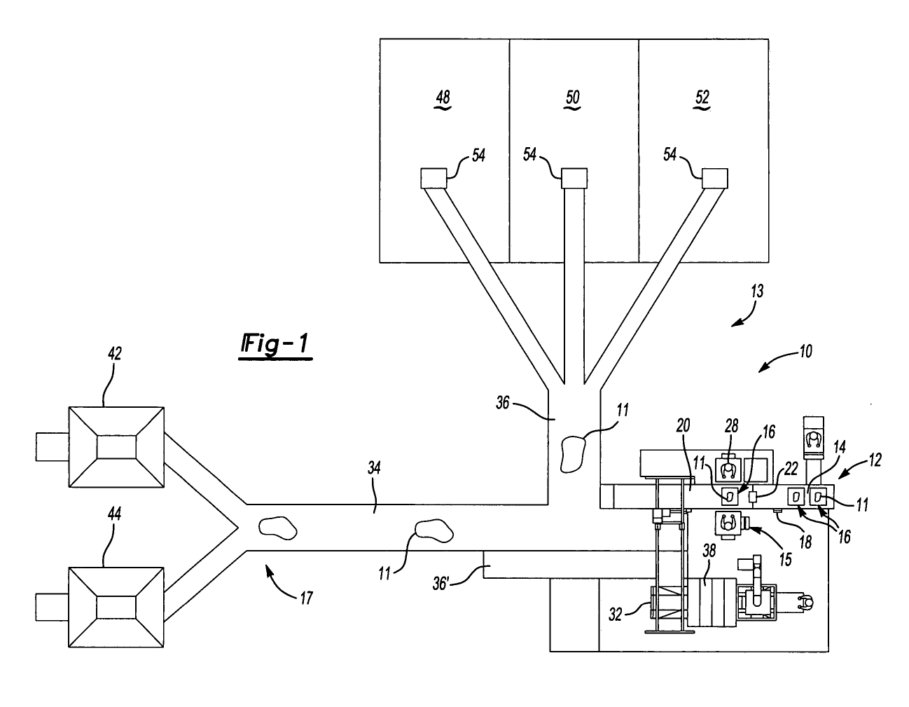

Referring to FIG. 1, a recyclable material sorting and processing system 10 is disclosed. The system 10 processes recyclable material 11 received from various distribution centers and prepares the recyclable material 11 for processing and reuse by manufacturers. The recyclable material 11 is received within containers 16. Preferably, each individual container 16 includes only one category of recyclable material 11, such as cans, plastic bottles or glass. The glass is preferably sorted by color such as brown, green and clear. The system 10 includes a sorting station 12, a glass bottle processing station 13 and a can and bottle processing station 17.

The glass bottle processing station 13, and can bottle processing station 17 receive recyclable material 11 from the sorting station 12 by way of conveyors 34, 36. The conveyor 36 includes an intermediate portion 36′ that dumps material onto the main conveyor 36. The conveyors 34, 36 continuously run during operation to move recyclable material 11 to the proper processing station. Each of the processing stations 13, 17 include item specific devices for processing the specific category of recyclable material 11. The glass bottle processing station 13 includes crushers 54 for crushing glass bottles and bins 48, 50, 52 for storing crushed glass by color. The can and plastic bottle station 17 includes a can crusher/baler 42, and a plastic bottle crusher/baler 44. The baled cans and plastic bottles provide for easier shipping and handling.

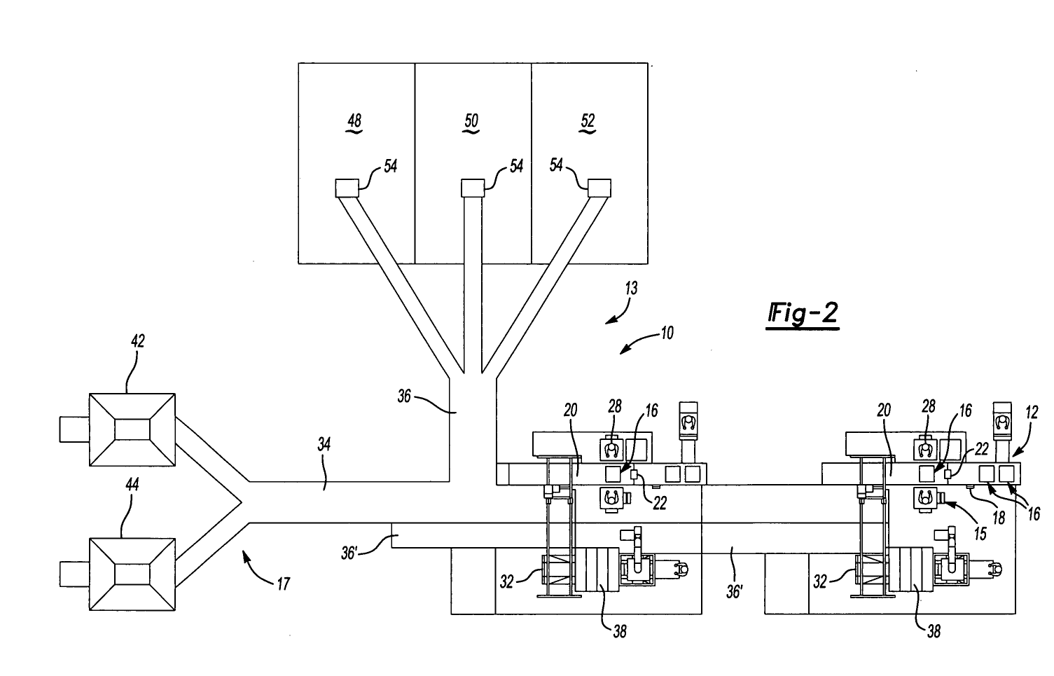

Referring to FIG. 2, the system 10 is shown with two sorting stations 12. As appreciated, multiple sorting stations 12 speed the sorting of recyclable material 11 and provide for adaptation to differing volumes of recyclable material 11. Each of the sorting stations 12 sort, and gather data relating to the incoming recyclable material 11. It is within the contemplation of this invention to include multiple sorting stations 12 to provide increased sorting capability. The recyclable material 11 is dumped onto conveyors 34, 36. However, multiple processing stations 13, and 17 can be provided for increasing the volume of recyclable material that can be processed.

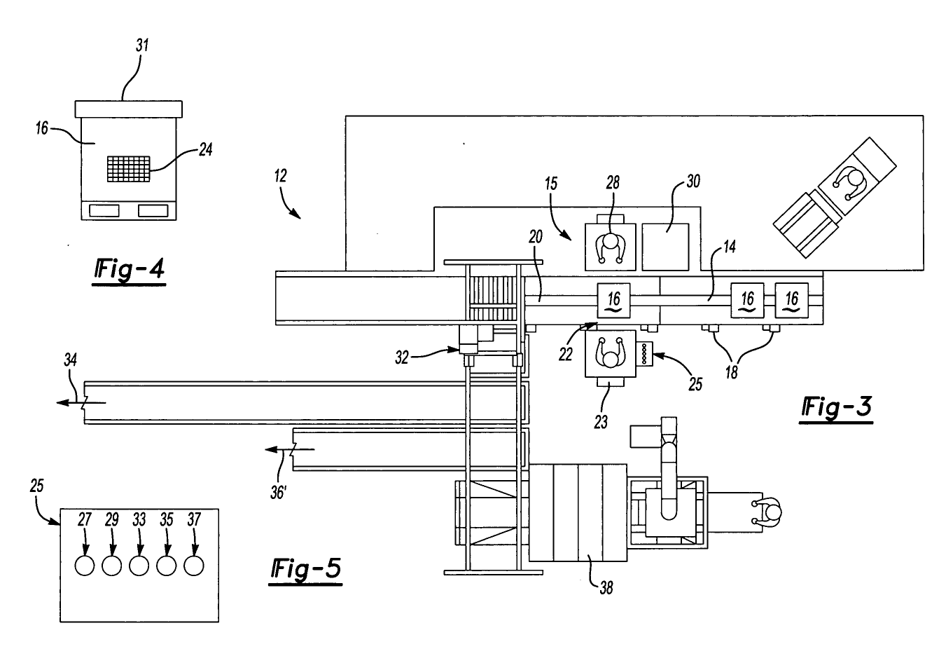

Referring to FIG. 3, the sorting station 12 sorts and collects data to track the amount and type of recyclable material 11 received from each distribution center. The containers 16 loaded on the load conveyor 14 move toward a data collection area 15 manned by at least one operator 28. Multiple containers 16 are loaded onto the load conveyor 14. Sensors 18 disposed on the load conveyor 14 and at the data collection area 15 control movement of the containers 16 toward the data collection area 15. Preferably, the sensors 18 are optic sensors as known in the art. However, a worker knowledgeable in the art with the benefit of this description would understand that any sensor for detecting the presence or absence of a container could be used in this invention to control movement of the containers 16.

Preferably each container 16 includes a computer readable label 24 (FIG. 3). The computer readable label 24 includes information pertaining to the origin of each container 16. Preferably, the computer readable label 24 is a bar code that is readably by a scanner 22 mounted within the data collection area 15. Although, a bar code and scanner are described, it is within the contemplation of this invention to use any type of computer readable identification label to allow automatic collection of data relevant to each container 16.

Referring to FIG. 4, preferably, the container 16 is a box structure defining a specified volume. A lid 31 covers the open top of the box to allow stacking of several containers 16 and to prevent contaminants and trash from entering the container 16. Further, the container 16 can include features such as openings to aid movement of the container during loading and unloading.

Referring back to FIG. 3, upon reaching the data collection area 15, the contents and origin of each container 16 are determined. The scanner 22 reads the computer readable label 24 and stores the information within a data acquisition system 23. The label 24 preferably at least includes information concerning the origin of the container 16, however, additional information may also be provided such as, date and time of shipping, tracking numbers, along with any other pertinent information useful in accounting and tracking recyclable material within the container 16.

The operator 28 attending the data collection area 15 removes the lid 31 of the container 16 and examines the contents. Preferably, each container 16 includes only one category of recyclable material 11. Preferably, the distribution center that shipped the material has presorted the recyclable material 11. The data collection station 15 includes a weigh conveyor 20. The container 16 is weighed and the weight of recyclable material within the container 16 is recorded in the data acquisition system 23 and matched to the origin information read from the computer readable label 24. The data acquisition system 23 stores data on the type and amount of recyclable material 11 received from each distribution center.

The operator 28 examines the contents of the container 16 and presses a corresponding switch on a control panel 25. Referring to FIG. 4, the control panel 25 includes switches 27, 29, 33, 35, and 37 that correspond to specific categories of recyclable material. Preferably, the categories of recyclable material include cans, plastic bottles, and glass bottles. The glass bottles are further defined by color such as brown, green and clear. The operator 28 presses the corresponding switch on the control panel 25 to record the type of recyclable material 11 within the container and match that data with information already recorded on the origin and weight of the recyclable material.

The system performs a check upon engagement of one of the switches 27, 29, 33, 35, and 37 to assure proper selection of recyclable material 11 category. The category of recyclable material 11 selected by one of the switches 27, 29, 33, 35, and 37 is compared to the weight of the container 16 and contents. If the material selected does not correspond with the weight, an error is signaled to the operator 28, prompting actuation of the correct switch 27,29,33,35, and 37. As appreciated, a container 16 full of plastic bottles will weigh much less than a container filled with glass bottles. Therefore a detected weight differential beyond a given range is brought to the attention of the operator 28 for correction.

The selection of one of the switches 27,29,33,35, and 37 also initiates movement of the container 16 from the data collection area 15. The container 16 moves further down the weigh conveyor 20 to a crane 32. The crane 32 lifts and moves the container 16 to one of the two conveyors 34,36. The contents of the container 16 are dumped onto the one of the conveyors 34, 36 and moved toward one of the processing stations 13,17. The container 16 is moved to a washing station 38. At the washing station 38 the container 16 is washed, dried and disassembled. The disassembled containers 16 are stacked and shipped back to various distribution centers for reuse.

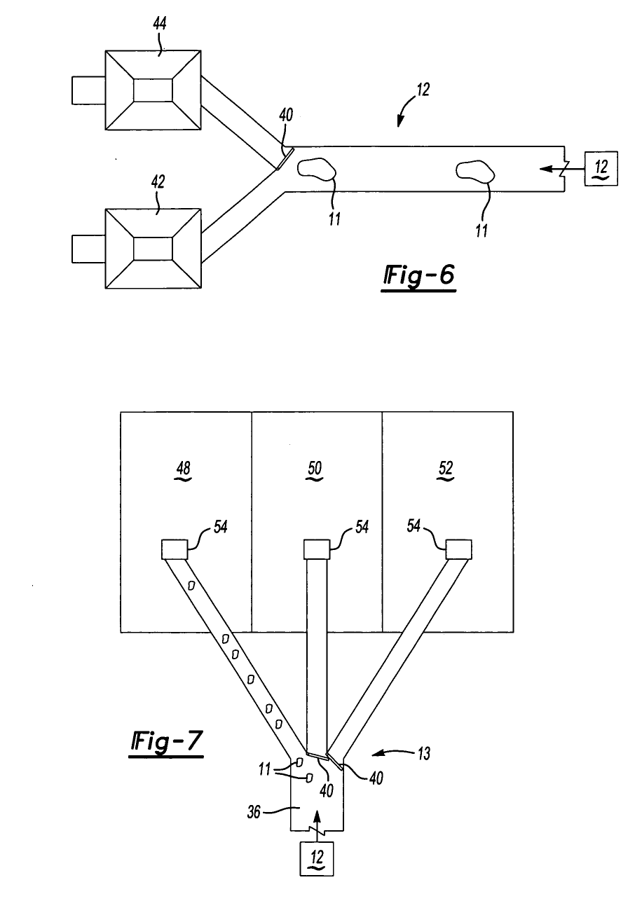

Referring to FIG. 6, the can and bottle processing station 17 is schematically shown and includes the conveyor 34 and a diverter arm 40. The cans and plastic bottles unloaded on the conveyor 34 move toward the first or second processing station 42, 44. The cans move to the first processing station 42. The first processing station 42 crushes, compacts and bales the cans. Plastic bottles are routed to the second processing station 44 that compacts, bales the plastic bottles. The output from each of the first and second processing stations 42, 44 provides for easy transportation to the end user of the recyclable material.

The diverter arm 40 moves to direct incoming recyclable material 11 to the proper processing station 42, 44. The switch actuated by the operator 28 initiates action by the diverter 40. Movement of the diverter 40 is coordinated with the speed of the conveyor 34 such that the proper category of recyclable material 11 is routed to the proper processing station 42, 44. The sequence of unloading the recyclable material from each container creates gaps of a predetermined duration between loads moving down the conveyor 34. The diverter 40 moves to direct the next oncoming load of recyclable material into one of the designated processing stations 44,42.

Referring to FIG. 7, the glass bottle processing station 13 is schematically illustrated and includes the conveyor 36. Glass bottles moving down the conveyor from the sorting station 12 are separated according to color. The bottles are separated into brown, green and clear glass. Each load of glass bottles is already separated and moves down the conveyor 36 toward segregated bins 48,50,52. Diverter arms 40 direct the glass bottles through a crusher 54 and into one of the bins 48, 50, 52 that correspond to the color of the glass. The color of the glass bottle is identified on the control panel 25 at the data collection station 15. The specific load of recyclable material 11 dumped from the specific container 16 is tracked from the unload point on the conveyor 36 to each bin 48,50, 52. The diverter arms 40 are opened or closed according to the selection made at the sorting station 12. The glass is dumped into the crusher 54 suspended over each of the bin 48, 50, 52. The output-crushed glass fills the segregated bins in preparation for reuse by glass manufactures or other manufactures reusing the crushed glass product.

Referring to FIG. 1, in operation, containers 16 of recyclable material 11 are loaded onto the load conveyor 14 at the sorting station 12. Sensors 18 regulate movement of each container 16 toward the data collection area 15. At the data collection area 15, the computer readable label 24 on the container 16 is read by the scanner 22. Information contained on the label 24 is stored in the data acquisition system 23. The operator 28 removes the lid 31 and examines the contents of the container 16. The operator 28 actuates one of the switches 27,29,33,35,and 37 corresponding to the category of recyclable material 11 within the container 16. The container 16 and contents are weighted by a weigh conveyor 20. The category type and weight information of recyclable material 11 contained within the container 16 is matched with the origin information read from the label are recorded within the data acquisition system 23. Actuation of one of the switches 27,29,33,35, and 37 initiates the gantry crane 32 to lift and move the container 16 to one of the conveyors 34,36. The crane 32 dumps the contents of the container onto the proper conveyor 34, 36 and unloads the container 16 at the washing station 38. The recyclable material 11 moves to one of the processing stations 13, 17. The specific load of recyclable material 11 is tracked from the sorting station 12 and diverted according to category to the desired processing station 13, 17.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

1. A method of sorting recyclable material comprising the steps of:
a) loading a container containing recyclable material onto a sorting station;
b) reading information stored on the container;
c) determining the category of recyclable material contained within the container,
d) weighing the container and recyclable materials within the container; and
e) unloading the recyclable material according to the determined category.

2. The method as recited in claim 1, comprising the step of unloading the recyclable material onto a conveyor, and moving the recyclable material according to the determined category.

3. The method as recited in claim 1, wherein said step a) further includes the step of loading multiple containers onto a conveyor and moving the containers to the sorting station.

4. The method as recited in claim 1, comprising sensing the presence of a container at the sorting station, and initiating said step b) in response to the sensed presence of the container.

5. The method as recited in claim 4, comprising a scanner reading a bar code corresponding to the container.

6. The method as recited in claim 5, wherein the bar code comprises information indicative of container origin.

7. The method as recited in claim 5, wherein the bar code comprises information indicative of container contents.

8. The method as recited in claim 1, wherein the contents of the container are unloaded on one of a first or second conveyor according to the category of recyclable material.

9. The method as recited in claim 8, wherein a crane lifts and moves the container to one of the first and second conveyors.

10. The method as recited in claim 8, wherein said first conveyor moves recyclable material to a first processing station.

11. The method as recited in claim 10, wherein said first processing station comprises a crusher for crushing glass.

12. The method as recited in claim 8, wherein the second conveyor moves recyclable material to a second processing station.

13. The method as recited in claim 12, wherein the second processing station comprises a crusher/baler for baling cans and plastic bottles.

14. A system for sorting and processing recyclable materials comprising:
a sorting station comprising a scale device for collecting information indicative of the weight of recyclable material within a container, a scanner for reading information relative to the container, and a commodity selector;
multiple conveyors corresponding to different categories of recyclable materials;
multiple processing stations corresponding to the different categories of recyclable materials for processing recyclable materials; and
a moving device for moving the container from the first station to a conveyor corresponding with the commodity selected, and dumping the contents of the container;

15. The system as recited in claim 14, wherein said sorting station comprises a load conveyor for receiving containers and moving the containers toward the scale device.

16. The system as recited in claim 14, wherein a sensor detects the presence of a container at said scale device, and initiates said scanner in response to detecting a container on said scale device, and initiates movement of a container from the load conveyor in responsive to a detected absence of a container on the scale device.

17. The system as recited in claim 14, comprising a category selector for indicating the category of recyclable material contained within said container.

18. The system as recited in claim 14, comprising a container washing station receiving containers from said moving device.

19. The system as recited in claim 14, wherein said scanner for reading information comprises a bar code reader, and the container includes a bar code containing information relating to origin and contents of the container.

20. The system as recited in claim 14, wherein said moving device comprises a crane for moving said containers.
